(19) United States
(12) Patent Application Publication
(10) Pub. No.: US 2015/0149213 A1
(43) Pub. Date: May 28, 2015

(54) MEDICAL CARE INFORMATION DISPLAY CONTROL APPARATUS, METHOD, AND MEDIUM

(71) Applicant: FUJIFILM CORPORATION, Tokyo (JP)

(72) Inventor: Fumitake TANAKA, Ashigarakami-gun (JP)

(73) Assignee: FUJIFILM CORPORATION, Tokyo (JP)

(21) Appl. No.: 14/547,646

(22) Filed: Nov. 19, 2014

(30) Foreign Application Priority Data
Nov. 25, 2013 (JP) 2013-242514

(51) Int. Cl. G06F 19/00

(52) U.S. Cl. CPC G06F 19/3487; G06F 19/322
USPC 705/3

(57) ABSTRACT

A medical care information display control apparatus, including a medical care item selection receiving unit that receives a selection of any of a plurality of medical care items, a medical care item sorting unit that sorts out a medical care item having medical care data with values that satisfy a similarity condition preset based on medical care data values of the selected medical care item from the plurality of medical care items, and a display control unit that graph displays only the medical care data of the selected medical care item and the medical care data of the sorted out medical care item, among medical care data of the plurality of medical care items, in the same display area using axes of the same scale.

### CROSS-REFERENCE TO RELATED APPLICATIONS

The present application claims priority under 35 U.S.C. §119 to Japanese Patent Application No. 2013-242514 filed on Nov. 25, 2013. The above application is hereby expressly incorporated by reference in its entirety, into the present application.

### BACKGROUND OF THE INVENTION

1. Field of the Invention

The present invention relates to a medical care information display control apparatus, method, and program for displaying medical care data of a plurality of medical care items.

2. Description of the Related Art

A system for displaying medical care data, such as, for example, a plurality of test results of a patient, on a display when a medical examination is performed by a doctor to determine the progress of a disease and a treatment policy has been proposed.

A wide variety of tests and treatments is performed on a patient and a comprehensive medical examination can be made by graph displaying and observing these numerous medical care data simultaneously.

### SUMMARY OF THE INVENTION

When a variety of medical care data described above is graph displayed, the axis of value for each type of medical care data will differ from data to data, as the value range of each type of medical care data is different.

In the meantime, there may be a case in which these graphs are displayed in the same display area simultaneously, as the display area for graphs is limited. In such a case, it is difficult to display the value axes of different scales for each type of medical care data having a different value range.

Therefore, the value at a changing point or the like in a graph of each type of medical care data cannot be read from the value axis. There is a method that displays a text representing the value at a changing point of a graph or the like in order to read the value, but it is very difficult to observe the graph, as the graph and the text overlap with each other.

Further, when a medical examination is performed by a doctor, there may be a case in which the doctor wants to attentively observe medical care data of a medical care item which is regarded as important for medical examination of a particular disease. In such a case, it is preferable that only a particular type of medical care data of attention is displayed among many medical care data.

Japanese Unexamined Patent Publication No. 2003-162580 and Japanese Unexamined Patent Publication No. 6(1994)-083880 propose a method that predetermines combinations of specific types of medical care data as templates or groups, and selects one of the templates or the groups to narrow down specific medical care data to be displayed.

In the method described in Japanese Unexamined Patent Publication No. 2003-162580 and Japanese Unexamined Patent Publication No. 6(1994)-083880, however, it is necessary to preset the templates or the groups in advance. Further, as newly added medical care data and the like are not included in the templates or the groups, the data cannot be the target of narrow down display unless a setting change is made to the templates or the groups.

In view of the circumstances described above, it is an object of the present invention to provide a medical care data display control apparatus, method, and program capable of displaying a plurality of graphs focusing on medical care data of a medical care item of attention and allows graph values to be read appropriately.

A medical care information display control apparatus of the present invention includes: a medical care item selection receiving unit that receives a selection of any of a plurality of medical care items; a medical care item sorting unit that sorts out a medical care item having medical care data with values that satisfy a similarity condition preset based on medical care data values of the selected medical care item from the plurality of medical care items; and a display control unit that graph displays only the medical care data of the selected medical care item and the medical care data of the sorted out medical care item, among medical care data of the plurality of medical care items, in the same display area using axes of the same scale.

In the medical care information display control apparatus of the present invention described above, the medical care item sorting unit may be a unit capable of sorting out a medical care item in a different unit of measurement from that of the medical care data of the selected medical care item.

Further, the similarity condition may be set based on a range from minimum to maximum values of the medical care data of the selected medical care item.

Still further, the similarity condition may be set based on an average value of the medical care data of the selected medical care item.

Further, the similarity condition may be set based on an average value and a standard deviation of the medical care data of the selected medical care item.

Still further, the similarity condition may be set based on a preset reference value for the medical care data of the selected medical care item.

Further, the medical care data of the plurality of medical care items may be those obtained in time series.

Still further, the display control unit may be a unit capable of displaying medical care data of at least three medical care items in the same display area.

Further, the medical care item sorting unit may be a unit that sorts out a medical care item in the same unit of measurement as that of the medical care data of the selected medical care item.

A medical care information display control method of the present invention includes the steps of: receiving a selection of any of a plurality of medical care items; sorting out a medical care item having medical care data with values that satisfy a similarity condition preset based on medical care data values of the selected medical care item from the plurality of medical care items; and graph displaying only the medical care data of the selected medical care item and the medical care data of the sorted out medical care item, among medical care data of the plurality of medical care items, in the same display area using axes of the same scale.

A medical care information display control program of the present invention causes a computer to function as: a medical care item selection receiving unit that receives a selection of any of a plurality of medical care items; a medical care item sorting unit that sorts out a medical care item having medical care data with values that satisfy a similarity condition preset based on medical care data values of the selected medical care item from the plurality of medical care items; and a display control unit that graph displays only the medical care data of the selected medical care item and the medical care data of the sorted out medical care item, among medical care data of the plurality of medical care items, in the same display area using axes of the same scale.

Note that the program of the present invention may be provided being recorded on a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object and executable code, and can be in any language including higher level languages, assembly language, and machine language.

According to the medical care information display control apparatus, method, and program of the present invention, a selection of any of a plurality of medical care items is received, then a medical care item having medical care data with values that satisfy a similarity condition preset based on medical care data values of the selected medical care item is sorted out from the plurality of medical care items, and only the medical care data of the selected medical care item and the medical care data of the sorted out medical care item, among medical care data of the plurality of medical care items, are displayed in the same display area using axes of the same scale. This allows a plurality of graphs focusing on the medical care data of a medical care item of attention to be displayed in the same display area, and values of the graphs can be read appropriately, since axes of the same scale are used. Further, this makes it easy to perform diagnosis based on medical care data and time required to reference the medical care data is reduced.

### BRIEF DESCRIPTION OF THE DRAWINGS

FIG. 1 is a block diagram of a medical care information display system that uses one embodiment of the medical care information display control apparatus of the present invention, illustrating the schematic configuration thereof.

FIG. 2 illustrates an example medical care information display screen.

FIG. 3 is a flowchart for explaining an operation of the medical care information display system illustrated in FIG. 1.

FIG. 4 is a drawing for explaining problem points when graphs of a plurality of medical care data are displayed in the same display area.

FIG. 5 illustrates an example in which medical care data are narrowed down to those in the same unit of measurement and graph displayed.

FIG. 6 illustrates an example in which only medical care data of a medical care item selected by the user and medical care data of a medical care item selected based on a preset similarity condition are graph displayed.

### DESCRIPTION OF THE PREFERRED EMBODIMENTS

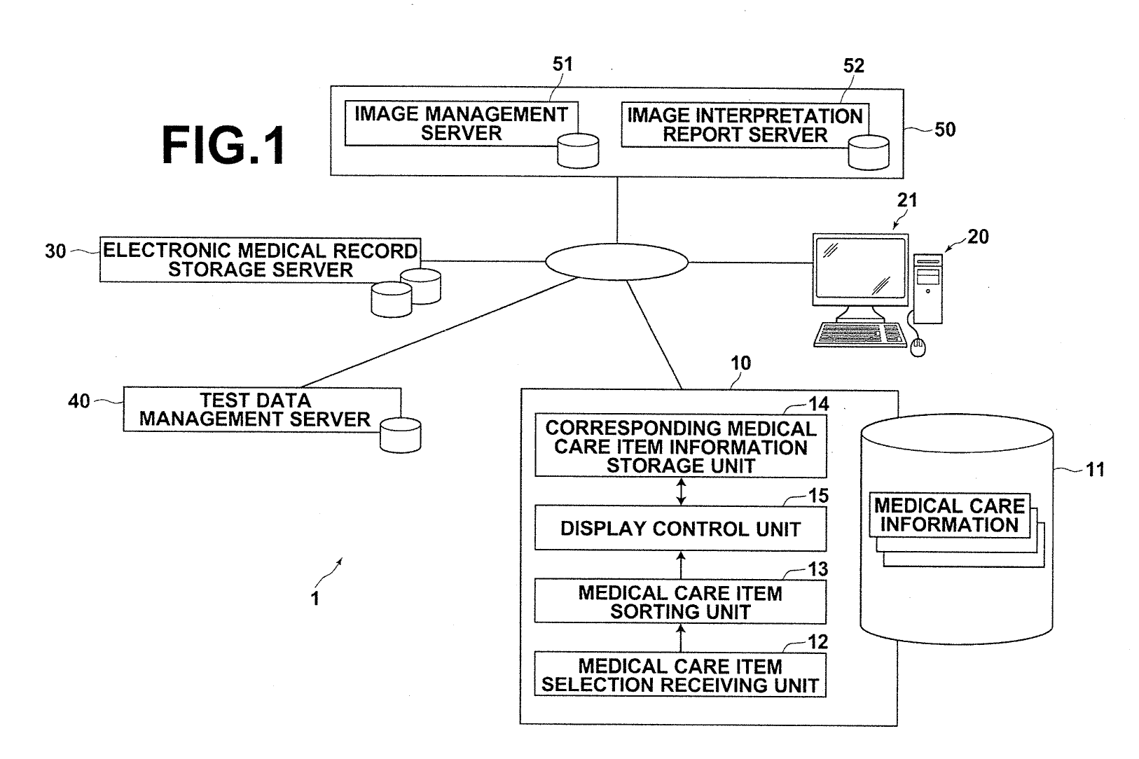

Hereinafter, a medical care information display system that uses one embodiment of the medical care information display control apparatus, method, and program of the present invention will be described with reference to the accompanying drawings. FIG. 1 is a block diagram of a medical care information display system 1 of the present embodiment, illustrating the schematic configuration thereof.

As illustrated in FIG. 1, the medical care information display system 1 of the present embodiment includes a medical care information display control apparatus 10, a diagnosis and treatment department terminal 20, an electronic medical record storage server 30, a test data management server 40, and an image diagnosis system 50, which are connected via a network, such as, for example, a wired or wireless LAN, or an Internet circuit.

The medical care information display control apparatus 10 receives identification information of a patient inputted at the diagnosis and treatment department terminal 20, collects medical care information of the patient from the electronic medical record server 30, the test data management server 40, and the image diagnosis system 50, generates a medical care information display screen by integrating the collected information, and displays the screen on the monitor 21 of the diagnosis and treatment department terminal 20.

More specifically, the medical care information display control apparatus 10 includes a medical care information storage unit 11, a medical care item selection receiving unit 12, a medical care item sorting unit 13, a corresponding medical care item information storage unit 14, and a display control unit 15, as illustrated in FIG. 1.

The medical care information display control apparatus 10 is a computer on which one embodiment of the medical care information display control program of the present invention is installed. The aforementioned medical care information storage unit 11, the medical care item selection receiving unit 12, the medical care item sorting unit 13, the corresponding medical care item information storage unit 14, and the display control unit 15 function when the medical care information display control program is executed by the central processing unit (CPU). The medical care information display control program described above may be a medical care information display control program recorded on a recording medium, down loaded from a server via the Internet or the like, or provided by SaaS (Software as a Service) via the Internet.

The medical care information storage unit 11 includes a storage device, such as a hard disk, and stores medical care information of a patient identified by identification information inputted from the diagnosis and treatment department terminal 20. The identification information of a patient and the medical care information of the patient are managed by relating to each other and medical care information is read out from the electronic medical record storage server 30, the test data management server 40, and the image diagnosis system 50 based on the identification information of the patient, and stored in the medical care information storage unit 11.

The medical care information may include basic information, such as the name, age, and gender of a patient, disease information that indicates a disease type of the patient, and various types of medical care data, including an amount of medication, an amount of drip infusion, a vital, a radiation image, and an ultrasound image. Note that the medical care data may be any type of data obtained for diagnosis and treatment of a subject.

For example, the basic data and the disease information included in the medical care information are read out from the electronic medical record of a patient in the electronic medical record storage server 30, but they are not necessarily obtained from the electronic medical record and they may be managed, for example, in another server and obtained from the server.

Medical care data, such as, the amount of medication, the amount of drip infusion, and vitals included in the medical care information are read out from the electronic medical record in the electronic medical record storage server 30, the test data, for example, sample test data, are read out from the test data management server 40, and the image information is read out from the image management server 51 of the image diagnosis system 50. But not limited to this, and medical care data stored, for example, in another server may be obtained.

The medical care item receiving unit 12 receives a selection of any medical care item to which the user, such as a doctor, pays attention from a plurality of medical care items for which medical care data have been obtained for a specific patient.

The medical care item sorting unit 13 sorts out a medical care item having medical care data with values that satisfy a similarity condition preset based the value range of medical care data of the medical care item selected at the medical care item selection receiving unit 12 from a plurality of medical care items.

The similarity condition described above is a condition for assuming a medical care item having a similar value range of medical care data to that of the medical care data of the medical care item selected by a user and is preset by the user based on the value range of the medical care data of the medical care item selected by the user.

More specifically, an example similarity condition may be whether or not all medical care data values are present in the range from minimum to maximum values of medical care data of the medical care item selected by the user. Further, the similarity condition is not limited to the range from the minimum to maximum values, and may be whether or not all medical care data values are present in a range obtained by adding or subtracting a preset value from the range from the minimum to maximum values, or in a range obtained by multiplying the range from the minimum to maximum values with preset ratios. Note that the upper and the lower limits of the ranges described above may have different values.

Further, the similarity condition may be set based on an average value of medical care data of the medical care item selected by the user. More specifically, whether or not all medical care data values are present in a preset range which includes the average value of medical care data of the selected medical care item may be set as the similarity condition. Still further, in this case, whether or not the average value of medical care data is present in the aforementioned range may be set as the similarity condition. A range with a value obtained by subtracting a preset value from the average value as the lower limit and a value obtained by adding a preset value to the average value as the upper limit may be the aforementioned preset range, or a range with lower and upper limits obtained by multiplying the average value with preset ratios may be set as the preset range. Note that the upper and lower limits of the aforementioned ranges may have different values.

When setting the similarity condition based on the average value of medical care data of the selected medical care item, the standard deviation of the medical care data may further be considered. More specifically, both conditions whether or not the average value of medical care data is present within a preset range which includes the average value of medical care data of the selected medical care item and whether or not a range of the standard deviation of medical care data is present within a preset range which includes the range of the standard deviation of medical care data of the selected medical care item. That is, whether or not the average value of medical care data is similar and whether or not the standard deviation of the medical care data is similar may be set as the similarity condition.

Further, the similarity condition may be set based on a reference value for the medical care data of the medical care item selected by the user. As for the reference value, for example, a normal value or a standard value for the medical care data of the selected medical care item may be used and the reference value is preset.

More specifically, whether or not all medical care values are present in a preset range which includes the reference value for the medical care data of the selected medical care item may be set as the similarity condition. Further, in this case, whether or not the reference value for medical care data is present in the aforementioned range may be set as the similarity condition. A range with a value obtained by subtracting a preset value from the reference value as the lower limit and a value obtained by adding a preset value to the reference value as the upper limit may be the aforementioned preset range, or a range with lower and upper limits obtained by multiplying the reference value with preset ratios may be set as the preset range, as in the average value. Note that the upper and lower limits of the aforementioned ranges may have different values.

The corresponding medical care item information storage unit 14 includes a table that associates disease information of a patient with a medical care item related to the disease information. Examples of the medical care item related to the disease information include a test item necessary to understand the progress of the disease, and items of, for example, medication and drip infusion necessary to treat the disease.

The display control unit 15 displays medical care data of a plurality of medical care items of a patient identified by the identification information on a medical care information display screen. More specifically, the display control unit 15 of the present embodiment list displays disease information of a patient and refers to the table stored in the corresponding medical care item information storage unit 14 based on the disease information selected from the list to identify a medical care item associated with the selected disease information, and obtains medical care data of the identified medical care item to display the data on the medical care information display screen in time series.

Then, if a selection of a medical care item to which an attention is paid by a user, among a plurality of medical care items associated with the disease information, is received by the medical care item receiving unit 12, as described above, the display control unit 15 of the present embodiment graph displays only the medical care data of the selected medical care item and the medical care data of the medical care item sorted out by the medical care item sorting unit 13 in the same display area using axes of the same scale. That is, if a medical care item of attention is selected by a user, the display control unit 15 of the present embodiment displays only the medical care data of the selected medical care item and the medical care data having values which are similar in range to the values of the medical care data of the selected medical care item, and medical care data of no other medical care items are displayed.

This allows display target medical care items to be narrowed down and the observation focusing on the medical care data of the medical care item of attention to be performed easily. Further, a comparison in magnitude between values of medical care data of different medical care items may be made easily, as medical care data of a plurality of medical care items are graph displayed using the same axis.

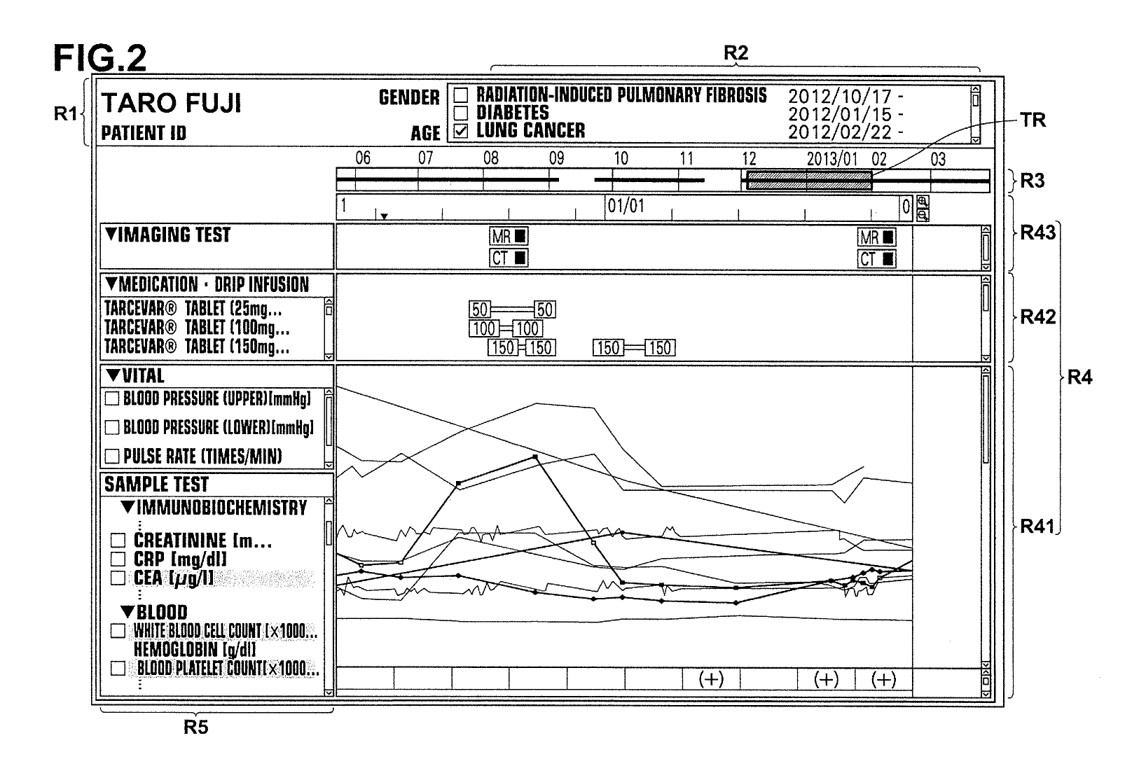

Next, a medical care information display screen, which is displayed on the monitor 21 of the diagnosis and treatment department terminal 20 by the display control unit 15, will be described. FIG. 2 illustrates an example medical care information display screen.

As illustrated in FIG. 2, the medical care information display screen includes a basic information display section R1, a disease information list display section R2, a medical care data obtaining period display section R3, a medical care data display section R4, and a medical care item list display section R5.

The basic information display section R1 is a section that displays basic information of a patient, such as identification information (patient ID), name, age, gender, and the like.

The disease information list display section R2 is a section that list-displays disease information of the patient identified by the identification information. Further, a checkbox is displayed for the information of each disease in the disease information list display section R2. When the user checks one of the checkboxes, medical care data display target disease information is selected from the list of disease information, and the selection information is obtained by the display control unit 15.

The medical care data obtaining period display section R3 is a section that displays a rough period during which medical care data have been obtained for the patient identified by the identification information. The horizontal axis of the medical care data obtaining period display section R3 represents a time axis and the right end indicates the current date and time. Basically, the medical care data obtaining period display section R3 displays a period in which medical care data are present as a horizontally extending bar-like graph. As it is a rough display here, if a period without any medical care data is shorter than a preset period, that period is assumed to be a period in which medical care data are present and a continuous bar-like graph is displayed.

The medical care data obtaining period display section R3 is a section that also receives an instruction to specify a display period of the horizontal axis of the medical care data display section R4 in which medical care data are displayed. As illustrated in FIG. 2, a rectangular region TR is inputted by the user in the medical care data obtaining period display section R3 and the period from the time point at the left end to the time point at the right end of the rectangular region TR is specified as the display period of the medical care data. Then, the display period specified in the medical care data obtaining period display section R3 is set as the scale of the horizontal display period of the medical care data display section R4. That is, the time point at the left end of the rectangular region TR is set to the time point at the left end of the medical care data display section R4 while the time point at the right end of the rectangular region TR is set to the time point at the right end of the medical care data display section R4. This allows the user to arbitrarily change the display period of the medical care data in the medical care data display section R4.

The medical care item list display section R5 is a section that displays a medical care item related to the disease information selected by the user in the disease information list display section R2. The medical care item related to the disease information is read out from the corresponding medical care item information storage unit 14 and displayed in the medical care item list display section R5 by the display control unit 15.

The medical care data display section R4 is a section that displays medical care data of the medical care item displayed in the medical care item list display section R5, and includes a numerical data display section R41, a medication period display section R42, and an image information display section R43.

The numerical data display section R41 is a section that displays, for example, sample test data obtained as test data, vital data, and blood test data, and can display numerical data as a graph, as illustrated in FIG. 2. The number of graphs displayed in the numerical data display section R41 depends on the number of medical care items related to the disease information, but at least three or more graphs may be displayed in the present embodiment.

A checkbox is displayed for each medical care item in the medical care item list display section R5. When a user checks one of the checkboxes, a medical care item to which the user pays attention is selected from a plurality of medical care items, and the selection information is received by the medical care item selection receiving unit 12. In this case, the graphs displayed in the numerical data display section R41 are only those of the medical care data of the medical care item selected by the user and the medical care data of the medical care item sorted out by the medical care item sorting unit 13. Here, the vertical scale of the numerical data display section R41 is set to one scale according to value ranges of the medical care data to be displayed as graphs.

The medication period display section R42 displays numerical data of medication amount and drip infusion amount in text form and indicates a period in which the medication or the drip infusion took place by a line segment extending horizontally.

The image information display section R43 is a section that displays image information, and may display text representing the modality of image information and a thumbnail of the image information. The position at which the thumbnail is displayed indicates the time point at which the image information was obtained. When the user selects a thumbnail displayed in the image information display section R43, the original image of the thumbnail is displayed on a separate screen.

The diagnosis and treatment department terminal 20 includes a monitor and input devices, such as a keyboard and a mouse. The monitor of the diagnosis and treatment department terminal 20 displays medical care information display screen illustrated in FIG. 2. The keyboard and the mouse of the diagnosis and treatment department terminal 20 receives various input operations performed by a user, including an input operation of patient identification information, and an input operation to specify a checkbox in the disease information list display section R2 and in the medical care item list display section R5.

The electronic medical record storage server 30 manages electronic medical records of a plurality of patients. The electronic medical record storage server 30 stores electronic medical records of a plurality of patients related to the identification information of the patients. The electronic medical record storage server 30 obtains patient identification information inputted at the diagnosis and treatment department terminal 20 and outputs information of the electronic medical record related to the identification information to the medical care information display control apparatus 10. As described above, the electronic medical record includes basic information of a patient, types and amounts of medical agents used for medication and drip infusion, period of medication, vital information, disease information, and the like.

The test data management server 40 is a server that manages test data of a plurality of patients, such as sample test data and blood test data. The test data management server 40 stores test data of a plurality of medical care items of each patient related to the identification information of the patients. The test data management server 40 obtains patient identification information inputted at the diagnosis and treatment department terminal 20 and outputs the test data related to the identification information to the medical care information display control apparatus 10. For the test data, a configuration may be adopted in which the test data are outputted once to the electronic medical record and retained in the electronic medical record. In this case, the test data are outputted from the electronic medical record to the medical care information display control apparatus 10.

The image diagnosis system 50 is a system that manages image diagnosis information of a plurality of patients. The image diagnosis system 50 includes an image management server 51 and an image interpretation report server 52. The image management server 51 stores image information, such as a radiation image, of each patient related to the identification information of the patient. The image interpretation server 52 stores an image interpretation report generated by a doctor through observation, for example, of a radiation image. The image interpretation report is related to the image information stored in the image management server 51 and stored. The image diagnosis system 50 obtains patient identification information inputted at the diagnosis and treatment department terminal 20 and outputs image information related to the identification information, its modality information, and its image interpretation report to the medical care information display control apparatus 10.

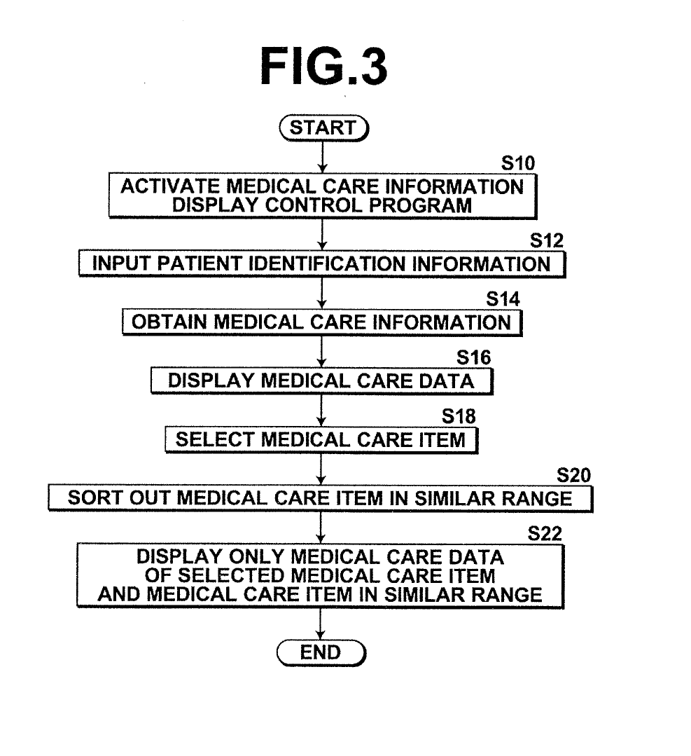

An operation of the medical care information display system 1 of the present embodiment will now be described with reference to the flowchart shown in FIG. 3.

First, a medical care data display control program is activated by a user at the diagnosis and treatment department terminal 20 and the medical care information display screen shown in FIG. 2 is displayed on the monitor 21 (S10).

Next, patient identification information is inputted at the diagnosis and treatment department terminal 20 and the patient identification information is obtained by the display control unit 15 of the medical care information display control apparatus 10 (S12).

The display control unit 15 reads out and obtains medical care information of the patient, including basic information, disease information, diseased period information of the disease information, and medical care data, from the electronic medical record storage server 30, the test data management server 40, and image diagnosis system 50 based on the inputted patient identification information, and temporarily stores the obtained medical care information in the medical care information storage unit 11 (S14).

Then, the basic information of the patient is read out by the display control unit 15 from the medical care information storage unit 11 and the basic information is displayed in the basic information display section R1 of the medical care information display screen.

Further, disease information of the patient is obtained by the display control unit 15 and list-displayed in the disease information list display section R2 of the medical care information display screen.

Next, information of at least one disease is selected by the user from the list of disease information displayed in the disease information list display section R2 by checking the checkbox of the disease information and the selection information is outputted to the display control unit 15.

Here, it is preferable that up to two checkboxes are selectable. The reason is that, when displaying graphs, two vertical axes may be provided, one on the left side and the other on the right side, and different target data may be displayed.

Further, an arrangement may be adopted in which the checkbox selected first is released when a third checkbox is selected.

Based on the inputted selection information of the disease information, the display control unit 15 obtains information of a medical care item related to the selected disease information with reference to the table stored in the corresponding medical care item information storage unit 14. Then, the display control unit 15 displays the obtained medical care item related to the selected disease information in the medical care item list display section R5 of the medical care information display screen. Further, the display control unit 15 reads out medical care data of the medical care item displayed in the medical care item list display section R5 from the medical care information storage unit 11 and displays the medical care data in the numerical data display section R41 (S16).

At this time, graphs of medical care data of all medical care items displayed in the medical care item list display section R5 are displayed in the numerical data display section R41. Although, the medical care data of each medical care item are in different units of measurement and the value ranges are also different, the display control unit 15 sets the scale of vertical axis for each medical care item according to the vertical size of the numerical data display section R41 such that the graphs of medical care data of all medical care items in the medical care item list display section R5 are displayed, and displays all the graphs in the same numerical data display section R41.

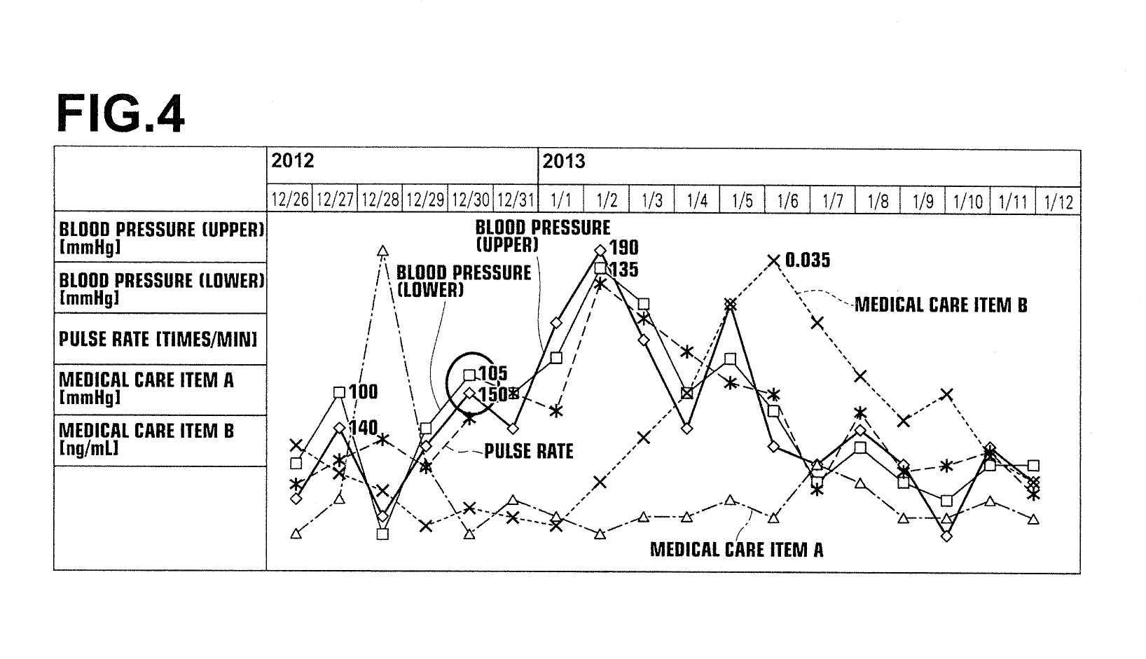

FIG. 4 shows an example graph display when the medical care items are “blood pressure (upper) [mmHg]”, “blood pressure (lower) [mmHg]”, “pulse rate [times/min]”, “medical care item A [mmHg]”, and “medical care item B [ng/mL]”. As shown in FIG. 4, all graphs can be displayed in the same display area (in the numerical data display section R41), but observation focusing on a graph of medical care data of a specific medical care item is difficult. Further, for example, the observation of the graphs of the “blood pressure (upper) [mmHg]” and the “blood pressure (lower) [mmHg]” shows that the plot positions in the area enclosed by a circle are reversed in the vertical direction with respect to the magnitudes of the respective values, as the scale of the vertical axe is different for each medical care item, causing the display to be difficult even to read the values of the medical care data.

To avoid such a problem, it is conceivable, when the observation focusing on, for example, the “blood pressure (upper) [mmHg]” is intended to perform, that only the medical care data of medical care items in the same unit of measurement are extracted and all the extracted medical care data are graph displayed with the vertical axes of the same scale.

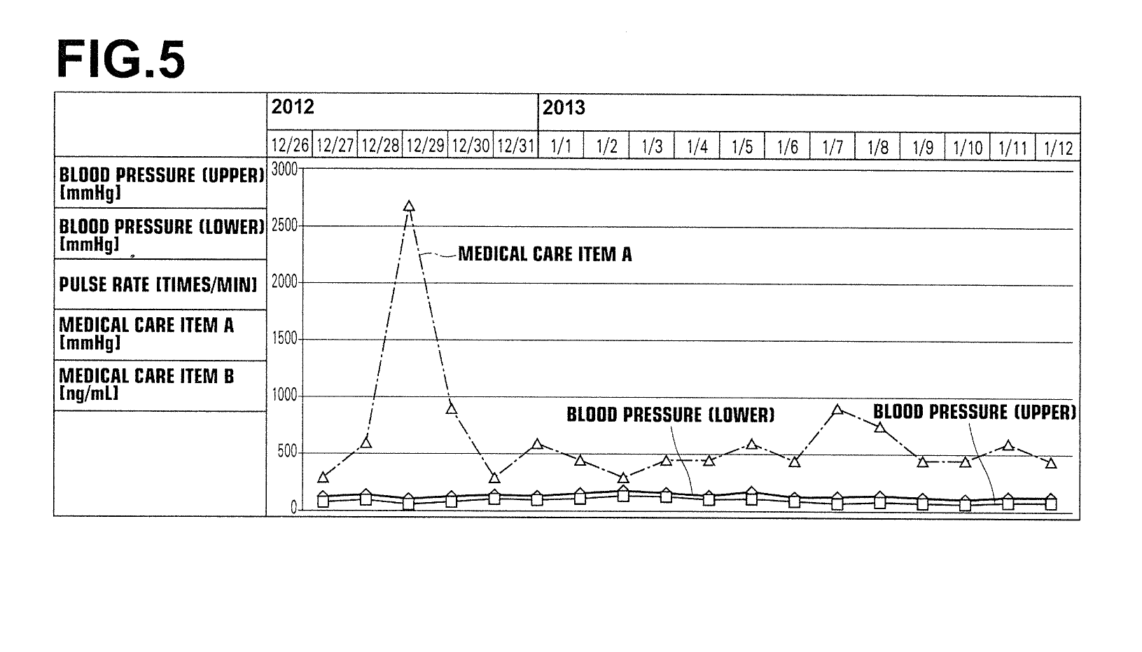

For example, if the medical care data shown in FIG. 4 are graph displayed in such a manner, the graphs of the “blood pressure (upper) [mmHg]”, “blood pressure (lower) [mmHg]”, and the “medical care item A [mmHg]” are displayed in the same display area with the vertical axes of the same scale. In this case, the value range of the “medical care item A [mmHg]” differs largely from the value ranges of the medical care data of the “blood pressure (upper) [mmHg]” and “blood pressure (lower) [mmHg]”, so that the graph display may result in that the changes in value of the medical care data of the “blood pressure (upper) [mmHg]” and “blood pressure (lower) [mmHg]” are almost unrecognizable, as shown in FIG. 5.

Consequently, the medical care information display system 1 according to the present embodiment performs graph display in the following manner. First, a medical care item to which the user pays attention is selected by checking the checkbox in the medical care item list display section R5 and the selection information is received by the medical care item selection receiving unit 12 (S18).

The selection information of the medical care item selected in the medical care item selection receiving unit 12 is inputted to the medical care item sorting unit 13. Based on the value range of medical care data of the selected medical care item, the medical care item sorting unit 13 sorts out a medical care item having medical care data with values that satisfy a preset similarity condition (S20).

Then, the display control unit 15 graph displays only the medical care data of the medical care item selected by the user and the medical care data of the medical care item sorted out by the medical care item sorting unit 13 in the same display area (in the numerical data display section R41) using axes of the same scale (S22).

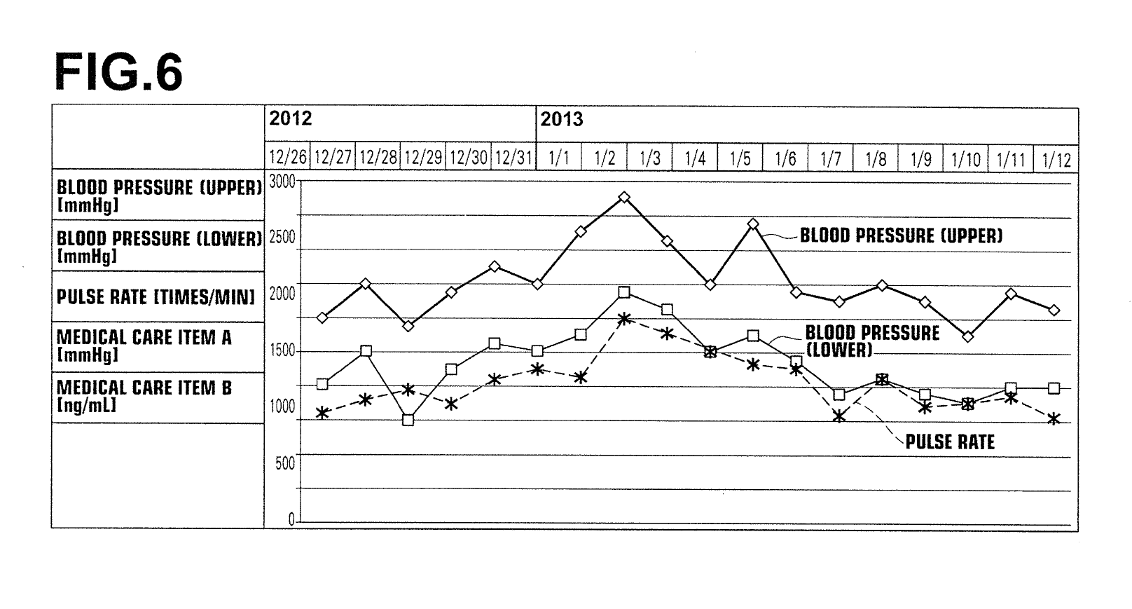

More specifically, if the “blood pressure (upper) [mmHg]” is selected by, for example, the user, the “blood pressure (lower) [mmHg]” and the “pulse rate [times/min]” having medical care data of similar value ranges are sorted out using a similarity condition preset based on the values of the medical care data of the selected “blood pressure (upper) [mmHg]”, and only the medical care data of the “blood pressure (upper) [mmHg]”, the “blood pressure (lower) [mmHg]”, and the “pulse rate [times/min]” are displayed using axes of the same scale, without displaying medical care data of the other medical care items, as illustrated in FIG. 6.

This facilitates the observation focusing on the medical care data of the “blood pressure (upper) [mmHg]”. Further, as the medical care data of the “blood pressure (upper) [mmHg]” and the “blood pressure (lower) [mmHg]” are graph displayed using axes of the same scale, values of the graphs can be read appropriately without reversion of the plot positions in the vertical direction with respect to the magnitudes of the values of medical care data described above.

Further, as the medical care data of a medical care item with values that satisfy a similarity condition set based on the medical care data of the selected medical care item, as described above, the medical care data of the “pulse rate [times/min]” in a different unit of measurement from that of the “blood pressure (upper) [mmHg]” and the “blood pressure (lower) [mmHg]” may also be displayed, as shown in FIG. 6, which may be observed as one of the diagnostic materials.

The simultaneous confirmation of blood pressure and pulse rate allows early check for stroke, angina, heart failure, heart disease, and the like.

Here, a description has been made of a case in which medical care data in different units of measurement are sorted out and displayed simultaneously, but medical care data in different units of measurement are not always sorted out and there may be a case in which only medical care data in the same unit of measurement are sorted out.

Further, an arrangement may be adopted in which medical care data that satisfy a similarity condition set based on medical care data of a medical care item selected by the user and in the same unit of measurement are sorted out.

Example combinations of medical care items that can be graph displayed appropriately by the medical care information display system of the present embodiment, like the “blood pressure (upper) [mmHg]” and the “blood pressure (lower) [mmHg]”, may include GTP (ALT) and GOT (AST) which are test items for liver diseases. GTP (ALT) and GOT (AST) are medical care items with comparable normal values and if a liver has an abnormality, the numerical values of both GTP (ALT) and GOT (AST) usually increase, so that their value ranges are often similar. As the numerical values of GTP (ALT) and GOT (AST) themselves, their magnitude relationship, and the like serve as the criteria for judging the progress of a disease, it is very useful to graph display these values appropriately, like the “blood pressure (upper) [mmHg]” and the “blood pressure (lower) [mmHg]”.

Further, the description has been made of a case in which medical care data obtained in time series are graph displayed, but the medical care data are not necessarily obtained in time series. That is, the horizontal axis of the numerical data display section R41 is not necessarily the time axis. For example, the horizontal axis may be delimited by value ranges like, for example, 1 to 10, 11 to 20, 21 to 30, and so on, and the medical care data may be represented in terms of frequencies in each value range.

What is claimed is:

1. A medical care information display control apparatus, comprising:
a medical care item selection receiving unit that receives a selection of any of a plurality of medical care items;
a medical care item sorting unit that sorts out a medical care item having medical care data with values that satisfy a similarity condition preset based on medical care data values of the selected medical care item from the plurality of medical care items; and
a display control unit that graph displays only the medical care data of the selected medical care item and the medical care data of the sorted out medical care item, among medical care data of the plurality of medical care items, in the same display area using axes of the same scale.

2. The medical care information display control apparatus as claimed in claim 1, wherein the medical care item sorting unit is a unit capable of sorting out a medical care item in a different unit of measurement from that of the medical care data of the selected medical care item.

3. The medical care information display control apparatus as claimed in claim 1, wherein the similarity condition is set based on a range from minimum to maximum values of the medical care data of the selected medical care item.

4. The medical care information display control apparatus as claimed in claim 1, wherein the similarity condition is set based on an average value of the medical care data of the selected medical care item.

5. The medical care information display control apparatus as claimed in claim 1, wherein the similarity condition is set based on an average value and a standard deviation of the medical care data of the selected medical care item.

6. The medical care information display control apparatus as claimed in claim 1, wherein the similarity condition is set based on a preset reference value for the medical care data of the selected medical care item.

7. The medical care information display control apparatus as claimed in claim 1, wherein the medical care data of the plurality of medical care items are those obtained in time series.

8. The medical care information display control apparatus as claimed in claim 1, wherein the display control unit is a unit capable of displaying medical care data of at least three medical care items in the same display area.

9. The medical care information display control apparatus as claimed in claim 1, wherein the medical care item sorting unit is a unit that sorts out a medical care item in the same unit of measurement as that of the medical care data of the selected medical care item.

10. A medical care information display control method, comprising the steps of:
receiving a selection of any of a plurality of medical care items;
sorting out a medical care item having medical care data with values that satisfy a similarity condition preset based on medical care data values of the selected medical care item from the plurality of medical care items; and
graph displaying only the medical care data of the selected medical care item and the medical care data of the sorted out medical care item, among medical care data of the plurality of medical care items, in the same display area using axes of the same scale.

11. A non-transitory computer-readable recording medium containing a program that causes a computer to function as:
a medical care item selection receiving unit that receives a selection of any of a plurality of medical care items;
a medical care item sorting unit that sorts out a medical care item having medical care data with values that satisfy a similarity condition preset based on medical care data values of the selected medical care item from the plurality of medical care items; and
a display control unit that graph displays only the medical care data of the selected medical care item and the medical care data of the sorted out medical care item, among medical care data of the plurality of medical care items, in the same display area using axes of the same scale.
